(19) United States
(12) Patent Application Publication
(10) Pub. No.: US 2024/0336803 A1
(43) Pub. Date: Oct. 10, 2024

(54) EPOXY COATING COMPOSITIONS

(71) Applicant: SWIMC LLC, Cleveland, OH (US)

(72) Inventors: Weih Q. LEE, Chaska, MN (US); John M. BRONK, Pine Island, MN (US); Rafael D. REYES, Minneapolis, MN (US)

(21) Appl. No.: 18/747,590

(22) Filed: Jun. 19, 2024

Related U.S. Application Data
(63) Continuation of application No. PCT/US2021/073071, filed on Dec. 22, 2021.

(51) Int. Cl. C09D 163/00; C08G 59/24; C08G 59/40; C08G 59/50; C08G 59/62; C09D 5/08

(52) U.S. Cl. CPC C09D 163/00; C08G 59/245; C08G 59/4021; C08G 59/4064; C08G 59/5033; C08G 59/506; C08G 59/621; C09D 5/08; C08G 2150/20; C08G 2150/90

(57) ABSTRACT

A coating composition for producing high performance heat-resistant coating materials for a variety of substrates including steel and metal and non-metal substrates as well as laminate structures and self-contained substrates. The coating composition includes an epoxy resin system comprising a fluorene-structured epoxy monomers and the like, along with a crosslinker or curing agent and a catalyst or catalyst package. The coating compositions when amine-, phenyl hydroxyl-, or carboxyl-functional may also be used as crosslinkers or curing agents.

### BACKGROUND OF THE INVENTION

Epoxy coatings are widely used in a variety of established and emerging fields of application, including general industrial applications, electronics, and others. The demand for these materials has been growing steadily over the years, and especially in the area of high temperature- or heat-resistant coatings.

Heat-resistant epoxy systems, such as those used in steel pipeline coatings in the oil and gas industry, for example, are expected to have glass transition temperatures (T_{g}) of greater than 200° C. For long-term corrosion protection for outer diameter (OD) pipe and downhole drill pipe inner diameter (ID) lining, high T_{g} coatings are sometimes required to prevent coating damage from high temperature-high pressure (HTHP) fluids that can reach temperatures of 200° C. or more as drill depth increases. In addition, these coatings must also demonstrate sufficient flexibility and impact resistance to remain holiday-free and provide uninterrupted operations during installation and service. Furthermore, these coatings must also have superior adhesion and moisture resistance relative to conventional epoxy coatings used in other applications.

Currently, epoxy systems used in high-temperature applications are formulated to have high chemical crosslinking density. Multifunctional epoxy resins are typically used for this purpose, and when used alone or in combination with other epoxy resins, can achieve cured Tg values of about 120° C. to 180° C. However, achieving such high Tg values often compromises other important performance characteristics of the coating, such as flexibility and toughness. High-end formulations of multifunctional epoxy resins incorporate isocyanate-modified resin grades that may allow formulations to attain Tg values of 180° C. to 200° C., but the bulk flexibility and toughness quickly deteriorate to a level too poor to sustain practical applications conditions. These coatings are generally too hard and brittle even when formulated without fillers or extenders.

Formulating epoxy coatings with Tg values greater than 200° C. remains challenging, particularly where coatings must also meet other stringent performance requirements. From the foregoing, it will be appreciated that there remains a need in various industries for heat-resistant epoxy coatings that also demonstrate optimal toughness, flexibility, impact resistance, and adhesion, among other properties.

### SUMMARY

The present description provides epoxy coatings that demonstrate, in the capacity of formulation, optimal heat resistance, flexibility, toughness, water or moisture uptake, and adhesion, especially when applied to metal substrates employed in a variety of different environments. First, the epoxy coatings described herein can be tailored to have Tg values greater than 200° C., preferably about 200° C. to 250° C. Second, the epoxy coatings described herein retain optimal performance characteristics or bulk properties, such as flexibility of greater than about 2.0°/PD and impact resistance greater than about 45 lb-in (approx. 5.0 J), even without the use of additional flexibilizers, toughening agents, and other additives. Third, the compositions described herein, when formulated properly, offer exceptional adhesion to metal substrates as tested by hot water soak/immersion, cathodic disbondment, or three-phase autoclave rating of 1, even in the absence of adhesion promoters. Fourth, the compositions described herein, when formulated properly, provide superior moisture impermeability as tested by hot water uptake of less than 10 g/m² after 28 days HWA at 95° C. Fifth, the epoxy coating technology described herein can be extended from epoxide-functional systems to amine- and phenol-functional systems and further to vinyl acrylic and carboxylic acid-functional systems, which could help resolve challenges associated with high temperature applications including, without limitation, substrates for 5G telecom networks, high performance busbar, injection molding, underfill adhesives, instant-cure acrylic compounds, advanced 3D printed materials, pressured hydrogen barrier coatings for durable storage and transportation.

The coating compositions described herein may be functional powder coating compositions such as fusion bonded epoxy (FBE) coatings, but also liquid coatings and adhesives, such as solvent-based paints, 100% solids systems, and the like.

In one embodiment, the present description provides compositions including at least one binder resin having the structure of a compound of general formula (I) or (II)

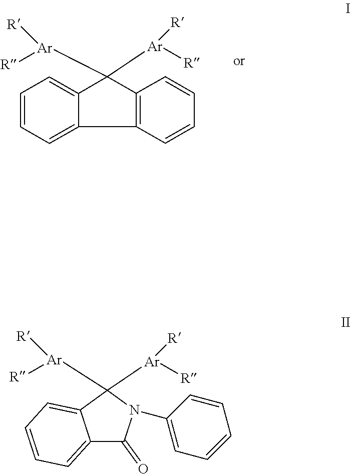

The at least one binder resin is part of a coating composition that also includes a crosslinker or hardener and a catalyst or a catalyst package.

In another embodiment, the present description provides a coating composition that includes at least one epoxy binder resin with a cured Tg of at least about 200° C., where the epoxy binder resin is a difunctional fluorene-based compound present in an amount of 0.5 to 100 percent by weight, based on the total weight of the epoxy binder resin. In addition, the coating composition described herein includes a crosslinker or hardener and a catalyst or a catalyst package.

In yet another embodiment, the present description provides a coating composition that includes at least one epoxy binder resin with a Tg of at least about 200° C., where the epoxy binder resin is a difunctional phenolphthalein-based compound present in an amount of about 0.5 to 100 percent by weight, based on the total weight of the epoxy binder resin. In addition, the coating composition described herein includes a crosslinker or hardener and a catalyst or a catalyst package.

In still another embodiment, the present description provides an epoxy-based coating composition including a crosslinker and a catalyst. The crosslinker is an epoxy curing agent such as a difunctional fluorene-based amine or phenol. In an aspect, the fluorene-based amine or phenol described herein may be used in combination with conventional epoxy resin binder systems or with epoxy resin binder systems including the difunctional fluorene-based or phenolphthalein-based monomers described herein.

In an embodiment, the present description provides coated articles that have the coating compositions described herein applied thereon. In one aspect, the coated articles are metal substrates with the coating compositions applied thereon, preferably structural steel substrates. In another aspect, the coated articles are non-metal substrates with the coating compositions applied thereon or self-contained substrates made using the compositions described herein, including laminate substrates, substrates made by injection molding, 3D-printed substrates, and the like.

The above summary of the present invention is not intended to describe each disclosed embodiment or every implementation of the present invention. The description that follows more particularly exemplifies illustrative embodiments. In several places throughout the application, guidance is provided through lists of examples, which can be used in various combinations. In each instance, the recited list serves only as a representative group and should not be interpreted as an exclusive list.

The details of one or more embodiments of the invention are set for in the accompanying drawings and the description below. Other features, objects, and advantages of the invention will be apparent from the description and drawings, and from the claims.

### Selected Definitions

Unless otherwise indicated, the term “polymer” includes both homopolymers and copolymers (i.e., polymers of two or more different monomers).

As used herein, the term “organic group” means a hydrocarbon group (with optional elements other than carbon and hydrogen, such as oxygen, nitrogen, sulfur, and silicon) that is classified as an aliphatic group, cyclic group, or combination of aliphatic and cyclic groups (e.g., alkaryl and aralkyl groups). Organic groups as described herein may be monovalent, divalent or polyvalent. The term “aliphatic group” means a saturated or unsaturated linear or branched hydrocarbon group. This term is used to encompass alkyl, alkenyl, and alkynyl groups, for example. The term “alkyl group” means a saturated linear or branched hydrocarbon group including, for example, methyl, ethyl, isopropyl, t-butyl, heptyl, dodecyl, octadecyl, amyl, 2-ethylhexyl, and the like. The term “alkenyl group” means an unsaturated, linear or branched hydrocarbon group with one or more carbon-carbon double bonds, such as a vinyl group. The term “alkynyl group” means an unsaturated, linear or branched hydrocarbon group with one or more carbon-carbon triple bonds. The term “cyclic group” means a closed ring hydrocarbon group that is classified as an alicyclic group or an aromatic group, both of which can include heteroatoms. The term “alicyclic group” means a cyclic hydrocarbon group having properties resembling those of aliphatic groups. The term “Ar” refers to a divalent aryl group (i.e., an arylene group), which refers to a closed aromatic ring or ring system such as phenylene, naphthylene, biphenylene, fluorenylene, and indenyl, as well as heteroarylene groups (i.e., a closed ring hydrocarbon in which one or more of the atoms in the ring is an element other than carbon (e.g., nitrogen, oxygen, sulfur, etc.)).

The term “phenylene” as used herein refers to a six-carbon atom aryl ring (e.g., as in a benzene group) that can have any substituent groups (including, e.g., hydrogen atoms, halogens, hydrocarbon groups, oxygen atoms, hydroxyl groups, etc.). Thus, for example, the following aryl groups are each phenylene rings: —C₆H₄—, —C₆H₃(CH₃)—, and —C₆H(CH₃)₂Cl—. Similarly, the term “naphthylene” refers to a 10-carbon atom aryl ring (e.g., as in a naphthalene group) that can have any substituent groups (including, e.g., hydrogen atoms, halogens, hydrocarbon groups, oxygen atoms, hydroxyl groups, etc.). For example, the following aryl groups are each naphthylene rings: —C₁₀H₆—, —C₁₀H₅(CH₃)—, and the like.

Suitable heteroaryl groups include furyl, thienyl, pyridyl, quinolinyl, isoquinolinyl, indolyl, isoindolyl, triazolyl, pyrrolyl, tetrazolyl, imidazolyl, pyrazolyl, oxazolyl, thiazolyl, benzofuranyl, benzothiophenyl, carbazolyl, benzoxazolyl, pyrimidinyl, benzimidazolyl, quinoxalinyl, benzothiazolyl, naphthyridinyl, isoxazolyl, isothiazolyl, purinyl, quinazolinyl, pyrazinyl, 1-oxidopyridyl, pyridazinyl, triazinyl, tetrazinyl, oxadiazolyl, thiadiazolyl, and so on. When such groups are divalent, they are typically referred to as “heteroarylene” groups (e.g., furylene, pyridylene, etc.).

Substitution is anticipated on the organic groups of the compounds of the present invention. When the term “group” is used herein to describe a chemical substituent, the described chemical material includes the unsubstituted group and that group with O, N, Si, or S atoms, for example, in the chain (as in an alkoxy group) as well as carbonyl groups or other conventional substitution. For example, the phrase “alkyl group” is intended to include not only pure open chain saturated hydrocarbon alkyl substituents, such as methyl, ethyl, propyl, t-butyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc.

The term “crosslinker” refers to a molecule capable of forming a covalent linkage between polymers or between two different regions of the same polymer. The term “crosslinker,” as used herein, is interchangeable with “hardener.” The term “curing agent” refers to a component that includes both (or can be used) as both “crosslinkers” or “hardener” and “catalyst” or “catalyst package.

Unless otherwise indicated, a reference to a “(meth)acrylate” compound (where “meth” is bracketed) is meant to include both acrylate and methacrylate compounds.

Unless otherwise indicated, all parts, ratios, and percentages are by weight and all molecular weights are number average molecular weight (Mₙ). Molecular weight may be determined by various techniques well known in the art. With respect to the components and/or compositions described herein, molecular weight is preferably determined by gel permeation chromatography (GPC).

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate.

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a coating composition that comprises “an” additive and catalyst can be interpreted to mean that the coating composition includes “one or more” additives and catalysts.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION

The present description provides a coating composition for use in high performance, heat-resistant applications. The coating composition may be applied to a variety of substrates, including metal and non-metal materials. The coating composition described herein includes a binder resin system having a thermally reactive fluorene- or phenolphthalein-based difunctional component, along with a crosslinker and a catalyst. The fluorene- or phenolphthalein-based component may also be used as a crosslinker or hardener.

The present description features a coating composition that includes a binder resin component that includes at least a thermally reactive difunctional monomer having the structure of a compound of general formula (I) or (II):

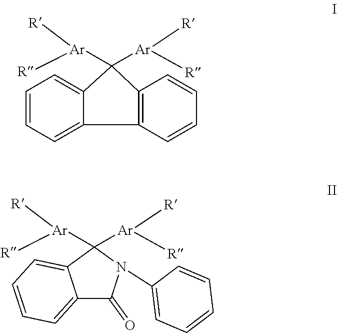

### Wherein

Ar is a C6 to C10 arylene group;
R′ is each independently a glycidyl or epoxide having the structure

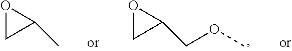

a monomeric acrylate, a polymer derived from one or more acrylate monomers, and mixtures or combinations thereof.

R″ is each independently —H, linear C1 to C4 alkyl, branched C1 to C4 alkyl, and mixtures or combinations thereof.

In some embodiments, the difunctional monomer described herein has a structure based on fluorene or, alternatively, on N-phenol phenolphthalein. Accordingly, in an aspect, where the difunctional monomer described herein is a compound having the structure shown in formula (I) or (II), “Ar” is a phenylene ring, such that the difunctional has the following structure(s):

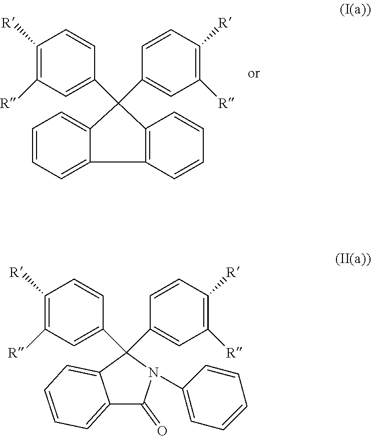

In these structures, each R′ is preferably a glycidyl or epoxide group that is either a monomeric epoxy, or an epoxy-functional polymeric component, or mixtures or combinations thereof:

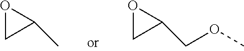

Alternatively, in an aspect, each R′ is preferably a (meth)acrylate monomer, or a polymer derived from one or (meth)acrylate monomers, or mixtures or combinations thereof. Exemplary (meth)acrylate monomers include, without limitation, acrylic acid, methacrylic acid, methyl acrylate, ethyl acrylate, propyl acrylate, butyl acrylate, 2-ethylhexyl acrylate, methyl methacrylate, ethyl methacrylate, propyl methacrylate, butyl methacrylate, 2-ethylhexyl methacrylate, hydroxyethyl acrylate, hydroxyethyl methacrylate, hydroxybutyl acrylate, hydroxybutyl methacrylate, glycidyl methacrylate, 4-hydroxybutyl acrylate glycidyl ether, 2-(acetoacetoxy)ethyl methacrylate (AAEM), diacetone acrylamide, acrylamide, methacrylamide, methylol (meth)acrylamide, styrene, α-methyl styrene, vinyl toluene, vinyl acetate, vinyl propionate, allyl methacrylate, and mixtures thereof. Preferred monomers include styrene, methyl methacrylate, methacrylic acid, acetoacetoxy ethyl methacrylate, butyl acrylate, and the like.

In some embodiments, the difunctional monomer described herein has a structure based on fluorene or on N-phenol phenolphthalein. Accordingly, in an aspect, where the difunctional monomer described herein has the structure shown in formula (I) or (II), “Ar” is a naphthylene ring, such that the difunctional monomer has the following structure(s):

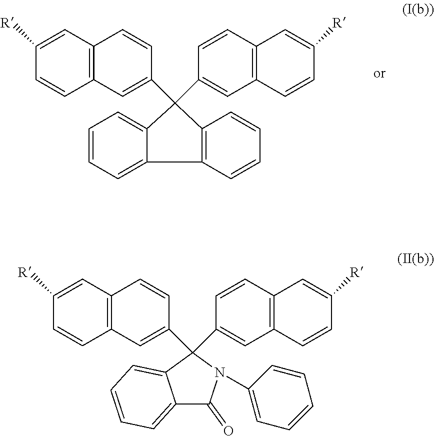

In these structures, each R′ is preferably a glycidyl or epoxide group that is either a monomeric epoxy, or an epoxy-functional polymeric component, or mixtures or combinations thereof:

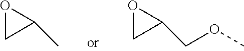

Alternatively, in an aspect, and as with compounds of structure (I(a)) or (I(b)), R′ is preferably a (meth)acrylate monomer, or a polymer derived from one or (meth)acrylate monomers, or mixtures or combinations thereof. Exemplary (meth)acrylate monomers include, without limitation, acrylic acid, methacrylic acid, methyl acrylate, ethyl acrylate, propyl acrylate, butyl acrylate, 2-ethylhexyl acrylate, methyl methacrylate, ethyl methacrylate, propyl methacrylate, butyl methacrylate, 2-ethylhexyl methacrylate, hydroxyethyl acrylate, hydroxyethyl methacrylate, hydroxybutyl acrylate, hydroxybutyl methacrylate, glycidyl methacrylate, 4-hydroxybutyl acrylate glycidyl ether, 2-(acetoacetoxy)ethyl methacrylate (AAEM), diacetone acrylamide, acrylamide, methacrylamide, methylol (meth)acrylamide, styrene, α-methyl styrene, vinyl toluene, vinyl acetate, vinyl propionate, allyl methacrylate, and mixtures thereof. Preferred monomers include styrene, methyl methacrylate, methacrylic acid, acetoacetoxy ethyl methacrylate, butyl acrylate, and the like.

The difunctional monomer having the structure of a compound of general formula (I) or (II) is used as part of a binder resin that makes up the coating composition described herein. The amount of the difunctional monomer is not particularly limited and is chosen based on the desired Tg and other properties and performance characteristics of the ultimate coating composition described herein. Accordingly, in some embodiments, the difunctional monomer is present as part of the total binder resin, in an amount preferably from 0.5 to 100% by weight, and more preferably 10 to 90% by weight of the total epoxide-functional components in the binder resin.

The coating composition described herein has a combination of desirable properties, including optimized Tg elevation, flexibility, heat resistance, impact resistance, adhesion, and barrier properties. In certain high end industrial applications, coating compositions with Tg as measured by differential scanning calorimetry (DSC) of at least 200° C., preferably 200° C. to 250° C., are desirable. For example, for long-term corrosion protection of oil and gas pipelines, especially of the outer diameter (OD) coating and the downhole drill pipe interior (i.e., inner diameter or ID) lining, optimal Tg is at least 200° C., preferably 200° C. to 250° C., which is necessary to prevent coating damage from high-performance, high-temperature (HTHP) fluids that could reach over 200° C. as the drill depth increases. In addition, these coatings must also demonstrate optimal flexibility, preferably greater than 2.0°/PD, and optimal impact resistance, preferably greater than 40 lb-in, more preferably greater than 45 lb-in, to avoid damage, i.e. remain holiday-free, for uninterrupted pipe installation and operations. Similarly, in high-end automotive and power control applications in the fast-evolving electronics industry, thermal conductive epoxy coatings and adhesives of high T_{g} up to 250° C. critical to insulated metal substrates or copper clad laminates (CCL as IGBT substrates) have been heavily pursued for years. In addition to T_{g}, low modulus or good flexibility and toughness are concurrently required in these electronics end uses.

Superior adhesion and moisture resistance are also important performance factors to consider in certain industrial applications. For example, pressured hydrogen barrier coatings (typically at 690 bar or 681 atm for storage, and at 207 bar or 204 atm for transportation), have to demonstrate impermeability to hydrogen atoms in order prevent hydrogen embrittlement of metals. Similarly, in other industrial applications, where stringent corrosion resistance specifications must be met (such as, ISO12944 C3-C5 specifications, for example), three-layer liquid coatings are typically used. In such systems, the layers include a zinc primer applied to the substrate (for adhesion), an epoxy base coat, and a polyurethane topcoat (for UV resistance). However, this conventional approach is costly and involves several processing steps.

Conventionally, it has been difficult to obtain epoxy coating compositions (i.e. BPA-based epoxy compositions and/or novolac-based epoxy compositions) that achieve T_{g} over 150° C. even when present in an amount as high as 100% of the total resin package. Although it is possible to formulate compositions that have Tg over 150° C., sometimes over 180° C. and even marginally up to 200° C. by using multi-functional epoxies, cured coatings derived from these formulations tend to be too brittle, i.e. these coatings lack sufficient or optimal flexibility of greater than 2°/PD. These coatings also lack optimal impact resistance of over 45 lb-in. Elevated T_{g} is fundamentally detrimental to flexibility and toughness, and higher Tg coatings demonstrate poor flexibility and impact resistance. In addition, it can be difficult to formulate highly flexible and tough epoxy coatings (such as used on rebar, on oil and gas OD pipes, and the like, for example) regardless of T_{g}.

Surprisingly, the compositions described herein address these formulation challenges by using binder resins, specifically epoxide-functional binder resins, that include difunctional monomers having the structure shown in general formulas (I) and (II). These difunctional compounds are, without limitation, monomers with epoxide-, amine-, phenyl hydroxyl-functionality, and the like, and in combination with appropriately designed cure chemistry and stoichiometric ratio, provide cured coatings with the optimal performance characteristics, such as, for example, T_{g} exceeding 200° C., flexibility more than 2.0°/PD (at normal filler loading of 25 to 35% by weight, based on the total weight of the formulation), and direct impact resistance or toughness greater than 45 lb-in are simultaneously achieved in a single formulation. When applied to super high-end oil and gas drill pipe interior linings as one example of HTHP applications, these performance characteristics exceed industry expectations and specifications.

Conventional epoxy resin systems include difunctional monomers, including commercially available DGEBA grades or derivatives, such as, for example EPON2004, where the difunctional monomers are linearly para-structured. In contrast, the epoxy resin systems that include the difunctional monomers described herein with the structures shown in general formulas (I) and (II), i.e. fluorene-based epoxies and phenolphthalein-based epoxies respectively, are vertically stacked with multiple benzene rings, bulky, and have three-dimensional (3D) rotational capability around the central carbon atom between the bifunctional epoxides. Without limiting to theory, it is believed that the enhanced performance of the cured epoxy coating described herein is because of the extremely bulky and hinged 3D structures of the difunctional monomers. Specifically, these structural features impact higher Tg through steric effects and physical entanglement effects in addition to chemical crosslinking, provide increased toughness through the cured bulk network, and increased flexibility because of 3D rotation around the central carbon atom.

In addition to high Tg, increased flexibility, and increased toughness, the coating compositions described herein are used to produce cured coatings with optimal water resistance and heat resistance. Without limiting to theory, it is believed that the cured coatings described herein demonstrate optimal heat resistance and water or moisture resistance (i.e. hydrophobicity) when the difunctional monomer having the structure shown in general formula (I) or (II) features preferably at least partially fused aromatic rings, more preferably fused naphthalene rings. Similarly, optimal heat resistance and hydrophobicity are seen when the difunctional monomer described herein is preferably symmetrical and purely hydrocarbon, i.e. when the difunctional monomer has a fluorene-based structure rather than a phenolphthalein-based structure.

Accordingly, in a preferred embodiment, the coating composition described herein includes a binder resin having a difunctional monomer based on fluorene. In an aspect, this difunctional monomer has the structure of a compound of general formula (I):

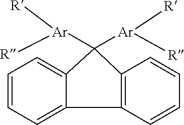

The difunctional monomer described herein has the structure of a compound of general formula (I), wherein each Ar— group is a phenylene ring or naphthylene ring. That is, in a preferred aspect, the difunctional monomer described herein has the structure of a compound of general formula (I(a)) or (I(b)):

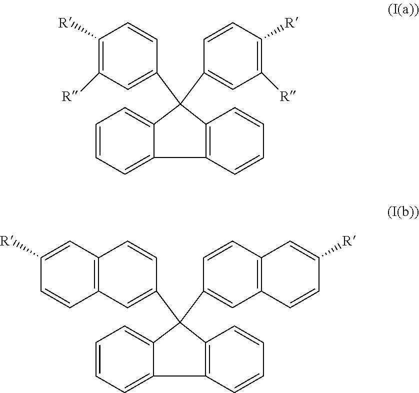

Without limiting to theory, it is believed that the presence of bulky aromatic groups attached to the fluorene structure may have a positive impact on certain performance characteristics, including heat resistance and hydrophobicity. Accordingly, in a preferred aspect, the difunctional monomer described herein has the structure of a compound of general formula (I(a)):

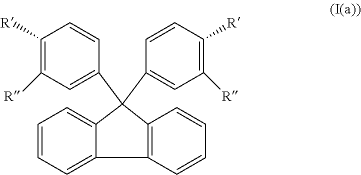

The present description provides specialty difunctional epoxy resin compositions useful in a wide variety of applications. Accordingly, in some embodiments, the difunctional monomer described herein is epoxy-functional. That is, the difunctional monomer described herein is a compound of general formula (I)

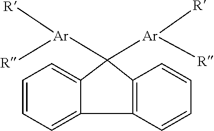

wherein —Ar— is an arylene group, R′ is preferably a glycidyl or epoxide group (either a monomeric epoxy component or an epoxy-functional polymeric component), and R″ is preferably H. Accordingly, in a preferred aspect, the difunctional monomer described herein has the following structure(s):

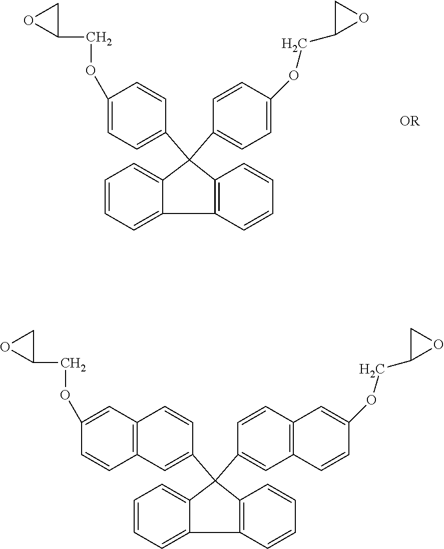 [SMILES: c1ccc2c(c1)-c1ccccc1C2(c1ccc(OCC2CO2)cc1)c1ccc(OCC2CO2)cc1 ; c1ccc2c(c1)-c1ccccc1C2(c1ccc2cc(OCC3CO3)ccc2c1)c1ccc2cc(OCC3CO3)ccc2c1]

The difunctional monomers described herein may be used as specialty epoxy compositions, either as part of a total epoxy resin system (by parts by weight or weight percentage), or as a complete resin system (at 100%). The selection of a difunctional monomer of particular structure and selection of the amount of monomer may be tailored to achieve certain composition properties and/or performance characteristics. For example, in a preferred aspect where high Tg of 200° C. to 250° C. is desired, the difunctional monomer described herein makes up preferably 0.5 to 100%, more preferably 10 to 90% by weight of the total epoxy-functional components in the coating compositions described herein.

Optionally, in some embodiments, the difunctional monomer described herein, e.g., when amine- or phenyl hydroxyl-functional, may be used as a curing agent or crosslinker for an epoxy resin coating composition. When used as a crosslinker or hardener in an appropriately formulated composition, the fluorene-based compounds described herein may synergistically enhance bulk toughness and flexibility of the cured coating. In an aspect, relative to conventional crosslinkers or curing agents, the fluorene-based compounds described herein produce coating compositions with enhanced toughness and flexibility even without the use of conventional flexibilizers or toughening agents, when used with any conventional epoxy resin coating system. In another aspect, the difunctional fluorene-based crosslinkers are optionally used as crosslinkers or curing agents for epoxy resin coating compositions that include the difunctional monomers described herein in the binder resin system. Without limiting to theory, it is believed that the use of fluorene-based curing with fluorene-based or phenolphthalein-based binder resin provides a coating composition that has more enhanced performance properties, especially with respect to toughness and flexibility.

Difunctional fluorene-based curing agents or crosslinkers, including fluorene-based phenolics, fluorene-based amines, and fluorene-based acids as described herein have the following generic chemical structures:

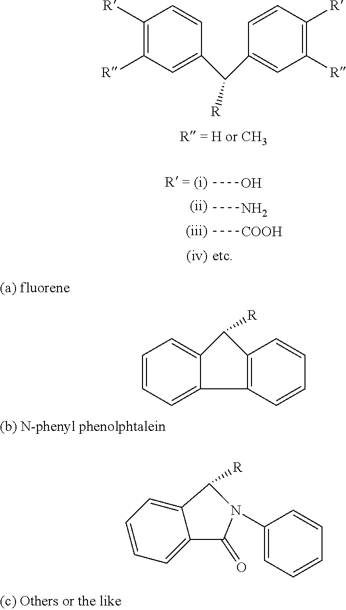

Of the potential chemistries shown above, (i) and (ii) are preferred, and represent phenolic and amine crosslinkers respectively. Specific examples include, without limitation, bisphenol fluorene (BPF; structure (i)(a), where R″ is H), biscresol fluorene (BCF; structure (i)(a), where R″ is —CH₃), bisaniline fluorene (BAF; structure (ii)(a), where R″ is H), and N-phenyl phenolphthalein bisphenol (PPP-BP; structure (i)(b), where R″ is H). These compounds have chemical structures and properties as shown below in Table A:

TABLE A
Tetra- and Di-functional Curing Agents or Crosslinkers

| | | Physical properties | | |
|---|---|---|---|---|
| Structure | Name and functionality | MW | Tm | EW |
| 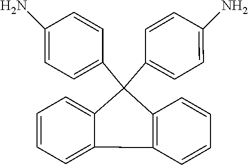 [SMILES: Nc1ccc(C2(c3ccc(N)cc3)c3ccccc3-c3ccccc32)cc1] | Bisaniline fluorene (BAF) f = 4 (NH) | 348 | 240° C. | 87.0 |
| 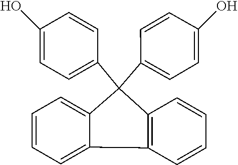 [SMILES: Oc1ccc(C2(c3ccc(O)cc3)c3ccccc3-c3ccccc32)cc1] | Bisphenol fluorene (BPF) f = 2 (Ph—OH) | 350 | 223° C. | 175 |
| 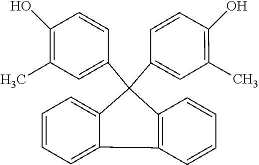 | Biscresol fluorene (BCF) f = 2 (Ph—OH) | 378 | 218° C. | 189 |
| 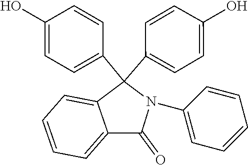 [SMILES: O=C1c2ccccc2C(c2ccc(O)cc2)(c2ccc(O)cc2)N1c1ccccc1] | N-phenyl phenolphthalein bisphenol (PPP-BP) f = 2 (Ph—OH) | 393 | 294-295° C. | 196.5 |

As shown in Table A, suitable curing agents (e.g. fluorene amines) and hardeners or crosslinkers (e.g. fluorene phenols) as described herein include difunctional compositions with high melting points, i.e. above at least about 218° C. and preferably within a range from 210 to 310° C. In addition, the steric, hydrophobic and rotatable structures provide superior barrier properties and toughness without compromising flexibility of the ultimate cured coating compositions. Without limiting to theory, structure-function relationships play a key role with respect to the difunctional curing agents or hardeners/crosslinkers shown in Table A, particularly when these curing agents or hardeners/crosslinkers are formulated within epoxy resin systems that include difunctional monomers as described herein, preferably difunctional fluorene-based epoxy resin systems. Cured coatings derived from fluorene-based epoxy resin systems formulated with fluorene-based curing agents or crosslinkers demonstrate enhanced adhesion, flexibility, toughness, and water impermeability, in addition to having the desired high Tg properties. Fluorene-based curing agents and hardeners as shown in Table A are commercially available, including, for example, from Osaka Gas Chemicals, Sabic Thermosets, and the like.

Alternatively, when curing agents or crosslinkers as shown in Table A are used with conventional epoxy systems, such as BPA epoxies and novolac epoxies, for example, significant improvement in flexibility and toughness is seen in cured coating compositions, although the optimal high Tg property is not necessarily seen with conventional epoxy systems.

In some embodiments, the coating composition including the difunctional monomers described herein optionally includes a conventional curing agent or hardener/crosslinker commonly used for curing epoxy resin systems and well known in the art. Examples include, without limitation, dicyandiamide (DICY), polyamines (aromatic, aliphatic, and cycloaliphatic), polyamides, Mannich bases, dihydrazides, amine adducts, phenolics, organic acids, anhydrides including di-anhydrides, polysulfides, thiols or mercaptans, isocyanates, and the like. The selection of conventional curing agents or hardeners is not so limited, and is typically determined by the desired properties of the ultimate cured coating. In an aspect, conventional curing agents or hardeners/crosslinkers may be used with fluorene-based curing agents or hardeners described herein when formulated properly.

The relative amounts of epoxy resins or monomers and a particular crosslinker or curing agent, defined in terms of the functional percentage of reactive epoxides that are both homopolymerized (with a catalyst or initiator) and co-polymerized (with a crosslinker), is governed by the formulation index or stoichiometric ratio, which ultimately determines the structure and properties of the cured bulk coatings. When conventional amine curing agents such as DICY are used, or when the curing agent is BAF as described herein, the formulation index of resin to crosslinker is preferably from 1:1 to 5:1, more preferably 1.05:1 to 3.0:1, and most preferably, 1.5:1 to 2.5:1. This preferred formulation index is necessary to maximize Tg, and provide optimal flexibility and toughness. Similarly, when conventional phenolic crosslinkers are used, or when the crosslinker is BCF or BPF as described herein, the formulation index of resin to crosslinker is preferably from 1:1 to infinite:1, more preferably from 1.025:1 to 5.0:1, and even more preferably from 1.05:1 to 2.5:1. This preferred stoichiometric ratio optimizes various performance characteristics of the cured bulk coating, including Tg, flexibility, toughness, and adhesion. In general, the greater the stoichiometric ratio, the more the crosslinking density of the ultimate coating is derived from epoxy homopolymerization. For this to occur, the formulation must include an adequate amount of specific types of catalysts that can activate homopolymerization of epoxies.

Accordingly, in some embodiments, the coating composition described herein includes a cure catalyst. Suitable catalysts are not particularly limited. Any conventional and modified tertiary amines, amine adducts, imidazoles, imidazole adducts, urea derivatives, all anionic, as well as Lewis acids, and onium salts, both cationic, may be used such as, for example, tertiary amines such as dimethylaminopyridine (DMAP), amine adducts such as Epikure P-100 granule from Hexion, imidazoles such as 2-methyl imidazole (2MI), imidazole adducts such as Cureduct P0505 from Shikoku, mixtures or combinations thereof, and the like. The amount or loading level of a particular catalyst is not particularly limited, but is determined by desired performance properties, gel and cure times, the formulation index, and extent of epoxy homopolymerization or epoxy-crosslinker copolymerization required. In an aspect, for the compositions as described herein, the amount of catalyst ranges from 0.01 phr to 5.0 phr, more preferably 0.1 phr to 2.5 phr, and even more preferably 0.25 to 1.5 phr.

In order to realize optimal performance characteristics including high Tg, the coating compositions described herein must be cured properly and adequately. If the cure temperature is not carefully controlled and maintained at a level higher than the Tg during the cure process, vitrification may occur, leading to under-curing and suboptimal performance characteristics for the ultimate coating. Accordingly, in some embodiments, the coating compositions described herein are subjected to an appropriate cure schedule. In a preferred aspect, the cure schedule includes (1) a post-cure oven temperature that is at least 5° C. to 10° C. above the Tg; and (2) an extended cure time at the applied cure temperature, where curing involves either applying the coating to a preheated substrate and allowing residual heat to cause curing, or by post cure in an oven as indicated above. The temperature for cure is not particularly limited, but should be chosen for Tg optimization.

Cured coatings made from the compositions described herein provide a number of useful performance characteristics. The cured coatings described herein have the optimal performance properties as shown in Table B, and demonstrate improved performance properties or characteristics relative to conventional fusion-bonded epoxy (FBE) coating compositions.

TABLE B
Optimal Performance Characteristics

| Performance | Inventive | |
|---|---|---|
| Characteristic | Composition | Comparative Composition |
| Tg | 200 to 250° C. | <200° C., typically <150° C. |
| Service temperature | <Tg, typically 10 to | <Tg, typically 10 to 20° C. |
| recommended | 20° C. below | below |
| Flexibility | <2°/PD (at −30 | <1°/PD (at −30 to 25° C.) |
| | to 25° C.) | |
| Toughness (impact | 80 to 160 lb-in | <80 lb-in, typically <60 lb-in |
| resistance) | | |
| Impermeability | <10 g/m² (95° | >30 g/m², typically 65 to |
| measured by | C.; hot water; | 110 g/m² |
| water uptake | 28 days) | |
| Dielectric stability | 0.56 to 1.33 kV/mil | <0.50 kV/mil |
| | (95° C.; 28 days) | |
| Adhesion (by | Rating 1 to 3 (free | Typically 3 to 5 (free of any |
| cathodic | of any adhesion | adhesion promoters) |
| disbondment?) | promoters) | |

The coating compositions described herein may be either liquid or powder compositions. In at least one embodiment, the coating composition described herein is a powder coating composition, preferably a fusion-bonded epoxy (FBE) system. Preferred compositions as described herein include a resin mixture prepared from a homogenous mixture of a specialty difunctional fluorene-based epoxy resin as described herein, and a conventional bi-functional epoxy resin such as, for example, DGEBA-based or novolac), or a multi-functional modified epoxy resin such as, for example, EPON165 or DER6510HT. The coating compositions described herein further include a conventional amine curing agent such as, for example, DICY, a conventional phenolic crosslinker, or optionally, a fluorene-based amine curing agent or phenolic crosslinker as described herein such as, for example, BAF, BPF, BCF, and PPP-BP), and mixtures or combinations thereof. In addition, the coating compositions described herein also include a tertiary amine catalyst or any others.

In at least one embodiment, the coating composition described herein is a powder fusion-bonded epoxy (FBE) system, where the resin composition is present in an amount of about 30 to 95 wt %, preferably 50 to 75 wt %, more preferably 55 to 70 wt %, and most preferably about 57.5 to 67.5 wt %, based on the total weight of the powder coating composition.

The coating compositions described herein may be made by any conventional methods or processes known in the art. In at least one embodiment, the polymeric binder resin component or resin mixture as described herein is dry mixed with any additives, functionalized pigments, fillers, and the like. The mixture is then melt-blended by passing through an extruder. The resulting extrudate is then solidified by cooling, and then ground or pulverized and sieved to form a powder coating composition as described herein. Depending on the desired coating end use, the grinding conditions are typically adjusted to achieve a powder median particle size of about 25 to 150 μm.

Alternatively, the additives described herein may be combined with other compositions to be added to the coating composition after extrusion, for example, as post-extrusion or post-blend or post-add additives. Suitable additives for addition after extrusion include those materials that improve dry flow or would not perform as well if added prior to extrusion.

Optionally, various additives may be included in the coating compositions described herein. Materials that provide a desired effect to the finished powder or the composition may be included, such as additives that improve application, melting, curing, or ultimate performance or appearance. Examples include, without limitation, pigments, fillers, other cure catalysts, antioxidants, color stabilizers, anti-corrosion additives, degassing additives, flow control agents, adhesion promoters, flexibilizers, toughening agents, and the like, and mixtures or combinations thereof.

The coating compositions described herein may be in liquid or powder form. In at least one embodiment, the coating composition is preferably a powder composition or formulation, more preferably an epoxy-based powder composition, where difunctional monomers as described herein are used as part of the binder resin component or system, including for example, difunctional fluorene monomers. The powder coating compositions described herein may be prepared as described and then may be applied to an article by various means known to those of skill in the art, including by the use of fluid beds and spray applicators, for example. Most commonly, an electrostatic spraying process is used, wherein the particles are electrostatically charged and sprayed onto a conductive article that has been grounded so that the powder particles are attracted to and cling to the article. After coating, the article is heated. This heating step causes the powder particles to melt and flow together to coat the article. Optionally, continued or additional heating may be used to cure the coating. Other alternatives such as UV curing of the coating may be used.

The coating compositions and methods described herein may be used with a variety of substrates and/or in a variety of applications or end uses. Typically and preferably, the powder coating compositions described herein are used to coat metal substrates, including without limitation, unprimed metal, clean-blasted metal, and pretreated metal, including plated substrates and ecoat-treated metal substrates. The metal substrates with the powder coatings applied thereon may be used in a wide variety of applications including, without limitation, structural steel members, pipelines (outer diameter, and inner diameter), substrates for highly corrosive environments, pipe, rebar, valves, fittings commonly used with pipe, and the like. In addition, in some embodiments, the compositions described herein may be used with high performance CCL, busbar, underfill adhesives, injection molding compounds, 3D printing, pressured hydrogen barriers, and the like.

### EXAMPLES

The invention is illustrated by the following examples. It is to be understood that the particular examples, materials, amounts, and procedures are to be interpreted broadly in accordance with the scope and spirit of the inventions as set forth herein. Unless otherwise indicated, all parts, ratios, and percentages are by weight and all molecular weights are number average molecular weight (Mₙ). An exemplary coating composition as described herein may include additional materials in varying concentrations. For example, the composition may further include one or more fillers, wet and dry flow agents, adhesion promoters, and combinations thereof. Unless otherwise specified, all chemicals used are commercially available from, for example, Sigma-Aldrich, St. Louis, Missouri.

### Test Methods

Unless indicated otherwise, the following test methods were utilized in the Examples that follow.

### A. Mandrel Bend Test

The flexibility of a cured coating as described herein is tested using the mandrel bend test according to NACE 0394 (Application, Performance, and Quality Control for Plant-Applied FBE External Pipe Coating) Appendix H. For the coatings described herein, testing was conducted at room temperature. Results are reported as the smallest radii over which a prepared sample can be flexed without failure of the applied coating or the dry film thickness of the coating.

### B. Direct Impact Test

The toughness of a cured coating as described herein is determined by direct impact resistance tested by the methods described in ASTM D2794 (Standard Test Method for Resistance of Organic Coatings to the Effects of Rapid Deformation). The coating to be tested is applied to a metal panel of a thickness previously agreed upon, typically a 0.032 inch thick panel is used. Once cured, a 2-lb. weight with a hemispherical tip of ⅝ inch diameter is dropped from a series of predetermined heights, measured in inches, onto the panel. “Direct impact” implies that the weight is dropped onto the coated face of the panel, resulting in a concave deflection when looking at the coated face. The impact resistance is noted as the greatest height from which the weight is dropped onto the panel, which does not result in cracking of the coating. Results are expressed as the weight dropped multiplied by the distance travelled in inches, with the unit of measure being “lb-in.”

### C. Gel Time Measurement

The viscosity behavior of a powder coating composition as described herein can be evaluated by measuring the gel time of the coating, according to the method provided in ASTM D4217-07 (2017) (Standard Test Method for Gel Time of Thermosetting Coating Powder) as referred to as CSA-Z245-20-2019 (Canadian Standards Association). Results are reported as the time (in seconds) for the coating composition to begin gelling at a particular temperature. For the compositions described herein, gel time is determined at 204° C.

### D. Inclined Plate Flow

Inclined plate flow or pill flow is a measure of the degree of melt flow or rheological behavior of a powder coating composition during the cure process. For the compositions described herein, the flow is determined according to the method provided in ASTM D4242 (Test Method for Inclined Plate Flow for Thermosetting Coating Powders). Results are reported as the distance of flow of a pill of powder over a plate inclined to a specified degree. For the compositions described herein, a 0.75 g pill is used and the test is conducted at a temperature of 150° C.

### E. Adhesion

This test is used to determine the adhesion of a cured coating to the substrate to which it has been applied. For the coatings described herein, adhesion is evaluated by delamination, blistering, softening, or swelling using a combination of the following three methods:
(i) Hot water soak: to determine the resistance to delamination as a result moisture or water uptake, the cured coatings described herein are tested using the method described in NACE Standard Appendix J. Testing is conducted at 75° C. and 95° C. over a period of 28 days. Results are reported on a scale of 1 to 5, where 1 represents an intact coating and 5 represents a coating that has failed, i.e. coating is delaminated or peels off the substrate.
(ii) Three-phase autoclave test: this method, as guided by the standard NACE TM0174 method is used to determine the adhesion and/or corrosion resistance of coatings applied to the inner lining of vessels and tanks used in processing oil and gas production fluids. Testing is conducted at 177° C. and 3500 psi over a 24-hour period. Results are reported on a scale of 1 to 5, where 1 represents an intact coating and 5 represents a coating that has failed, i.e. coating is delaminated or peels off the substrate.
(iii) Cathodic disbondment: this represents a mode of failure for coating compositions exposed to highly corrosive environments, such as with coatings applied to the exterior of pipes in the oil and gas industry, for example. For the coatings described herein, the test used is CSA Z245.20 Section 12.8.

### I. Moisture Resistance

This test is used to determine the moisture or water resistance of a cured coating. Test samples are immersed in water at a temperature of 75° C. and 95° C. for 28 days. Results are reported as the g/m² of water absorbed by the coating composition. The lower the reported number, the better the coating's resistance to moisture or water.

### J. Dielectric Strength

For the coating described herein, this test is used to evaluate voltage breakdown in terms of kV/mil, and is performed according to the method described in ASTM D149.

### EXAMPLE 1. Preparation of Coating Composition

Exemplary coating compositions as described herein, 1A to 4A, 5B to 11B, and 12C to 13C, were prepared by homogenizing the components indicated in Tables 1-3. The coating compositions are then applied by standard methods such as spray or fluid bed application to blasted steel test panels, and where cured coatings are being tested, the samples are allowed to cure to a film thickness of 12 to 16 mil (approx. 300 to 400 μm).

### EXAMPLE 2. Performance Testing

Various performance properties of the exemplary coatings prepared in Example 1 were tested according to standard methods described herein. Results of these tests are shown in Tables 1-3.

TABLE 1
Coating Components and Performance Characteristics

| | Exam- | Exam- | Exam- | Exam- |
|---|---|---|---|---|
| | ple | ple | ple | ple |
| Formulation: | 1A | 2A | 3A | 4A |
| Fluorene epoxy A, % | 30 | 50 | 83 | 0 |
| Fluorene epoxy B, % | 0 | 0 | 0 | 83 |
| Isocyanate-modified co-resin | 70 | 50 | 17 | 17 |
| (EEW 472), % | | | | |
| Curing agent (DICY: EW-NH | 5.26 | 5.84 | 6.05 | 5.16 |
| 21.0), phr | | | | |
| Catalyst (amine adduct), phr | 0.936 | 0.936 | 0.936 | 0.936 |
| Stoichiometric ratio | 1.02 to 1.69 for all | | | |
| (formulation index) | | | | |
| Filler loading of total | 25.2% for all | | | |
| formulation, % | | | | |
| Gel time at 204° C., sec | 14.1 | 9.6 | 9.7 | 49.0 |
| Pill flow (0.75 g at 150° C.), mm | 62.8 | 56.8 | 84.4 | 38.0 |
| T_{g} by DSC, ° C. | 208.1 | 214.0 | 224.3 | 243.4 |
| Flexibility at RT, °/PD | 2.67 | 2.34 | 2.05 | 1.55 |
| Direct impact resistance, lb-in | 80-100 | >80 | >80 | 80-100 |
| Dielectric strength*, kV/mil | ND | ND | 0.99 | 0.95 |
| Rating, HWA 75 and 95° C. for | 1 | 1 | 1-2 | 1 |
| 28 days | | | | |
| Water uptake, g/m² (95° C.) | 9.07 | ND | 8.32 | 12.85 |
| Rating, 3-phase autoclave | 1 | ND | 1 | ND |
| (177° C., 3500 psi, and | | | | |
| 24 hours) | | | | |

In Example 1A, the composition meets and exceeds the performance requirements for super high-end ID drill pipe applications in terms of T_{g} (>200° C.), flexibility (>2.0°/PD at RT), and impact resistance (>45 lb-in). The single coat with film thickness of 12 to 16 mil on blasted steel also passed three phase autoclave testing without demonstrating any defects such as delamination, blisters, and swelling, indicating excellent adhesion and barrier performance.

TABLE 2
Coating Components and Performance Characteristics

| | Example | Example | Example | Example | Example | Example | Example |
|---|---|---|---|---|---|---|---|
| Formulations: | 5B | 6B | 7B | 8B | 9B | 10B | 11B |
| Fluorene epoxy A, | 0 | 64 | 0 | 0 | 0 | 0 | 0 |
| % | | | | | | | |
| Fluorene epoxy B, | 83 | 0 | 68.4 | 0 | 0 | 0 | 0 |
| % | | | | | | | |
| PPP-BP epoxy, % | 0 | 0 | 0 | 0 | 0 | 83 | 0 |
| Isocyanate-modified | 17 | 36 | 31.6 | Novolac | Novolac | 17 | Novolac |
| co-resin (EEW 472), | | | | (EEW800): | (EEW800): | | (EEW800): |
| % | | | | 100 | 100 | | 100 |
| Curing agent | BAF | conv | conv | BPF | BCF | DICY | PPP-BP |
| | | phenolic | phenolic | | | | |
| Catalyst, phr | 1.02 | 0.36 | 0.36 | 0.53 | 0.53 | 0.94 | 1.40 |
| Stoichiometric ratio | 1.5 to 2.5 | 1.0 to 2.0 | 1.0 to 2.0 | 1.0 to 2.0 | 1.0 to 2.0 | 1.0 to 1.7 | 1.0 to 2.0 |
| (formulation index) | | | | | | | |
| Filler loading, % | 25.2 | 25.6 | 25.6 | 26.2 | 25.9 | 25.2 | 22.4 |
| Gel time at 204° C., | 8.0 | 8.9 | 7.0 | 7.8 | 9.5 | 8.9 | 4.5 |
| sec | | | | | | | |
| Pill flow (0.75 g, | 74.3 | 130.9 | 52.1 | 31.9 | 32.0 | 131.9 | ND |
| 150° C.), mm | | | | | | | |
| T_{g} by DSC, ° C. | 244.8 | 135.2 | 150.6 | 117.5 | 119.6 | 227.3 | 117.4 |
| Flexibility at RT, | 1.20 | 4.34 | 3.11 | 3.06 | 1.93 | 1.39 | 2.24 |
| °/PD | | | | | | | |
| Impact resistance, | >60 | 80-100 | 140-160 | ≥160 | >100 | 60-80 | 30-40 |
| lb-in | | | | | | | |
| Dielectric*, kV/mil | 0.95 | ND | ND | 0.56 | 1.05 | 1.33 | ND |
| Rating, HWA 75 | 2-3 | 2-3 | 1 | 2-3 | 1-2 | 1-2 | 1 |
| and 95° C. for 28 days | | | | | | | |
| Water uptake, g/m² | 9.08 | 8.50 | 12.58 | 9.10 | 12.10 | 23.44 | 12.80 |
| (95° C.) | | | | | | | |

Examples 5B, 8B, 9B and 11B employed BAF, BPF, BCF and PPP-BP as the curing agent or crosslinker instead of conventional DICY or conventional phenolics, while the epoxy resin or monomer package varied depending on intended end performance and applications. The PPP-BP epoxy cured by DICY (Example 10B) showed water uptake at 23.44 g/m², worse than other example formulations, including those cured by fluorene amines or phenolics. This is attributable to the difference in structure and chemistry. Dielectric strength overall stabilized over 0.56 to 1.33 kV/mil after degradation of HWA 95° C. for 28 days in comparison to typically well under 0.50 kV/mil for conventional formulations.

TABLE 3
Coating Components and Performance Characteristics

| | Example | Example |
|---|---|---|
| Formulation: | 12C | 13C |
| Fluorene epoxy A, % of all epoxy resins | 16.60 | |
| Conventional co-resin (EEW 215, f 5.5-6.0), | 24.25 | |
| % | | |
| Isocyanate-modified co-resin (EEW 472), % | 59.15 | |
| Curing agent (4,4′-DDS: EW-NH 62.0), phr | 7.785 | |
| Catalyst (amine adduct), phr | 1.10 | |
| Stoichiometric ratio (formulation index) | 2.425 | |
| Filler loading of total formulation, % | 19.7 | 14.3 |
| Gel time at 204° C., sec | 50.8 | 45.8 |
| Pill flow (0.75 g at 150° C.), mm | 55.8 | 57.4 |
| T_{g} by cured film DSC, ° C. | 202.4 | 202.4 |
| Flexibility at RT, °/PD | 2.00 | 2.00 |

Examples 12C and 13C demonstrate that even formulations with low levels of fluorene epoxy (i.e. as little as 16.60% of total resins) met super high-end ID drill pipe application performance requirements, i.e. T_{g}>200.0° C., flexibility at room temperature equal to or greater than 2.00°/PD, and impact resistance about 45 lb-in combined. In addition, because fluorene epoxy levels are low, these compositions may also be more cost-effective than existing conventional coatings.

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims. The invention illustratively disclosed herein suitably may be practiced, in some embodiments, in the absence of any element which is not specifically disclosed herein.

1. A composition, comprising:
a binder resin, comprising about 0.5 to 100 percent by weight of a difunctional monomer having the structure of a compound of general formula (I) or (II): 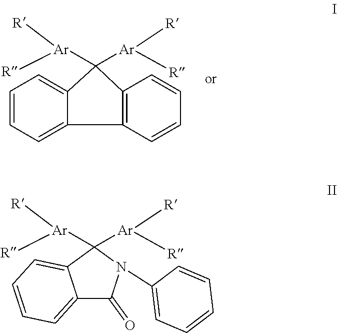
wherein
Ar is a C6 to C10 arylene group;
R′ is each independently a monomeric glycidyl or epoxide having the structure 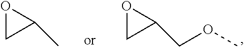
Or a monomeric acrylate, a polymer derived from one or more acrylate monomers, and mixtures or combinations thereof,
R′ is each independently —H, linear C1 to C4 alkyl, branched C1 to C4 alkyl, and mixtures or combinations thereof;
a crosslinker; and
a catalyst.

2. The composition of claim 1, comprising an epoxy binder system, wherein the compound having the general structure of formula (I) is a difunctional fluorene-based monomer having the structure:

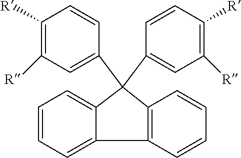

3. The composition of claim 1, comprising an epoxy binder system, wherein the compound having the general structure of formula (II) is a difunctional N-phenyl phenolphthalein-based monomer having the structure

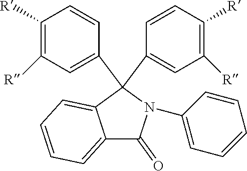

4. The composition of claim 1, comprising an epoxy binder system, wherein the compound having the general structure of formula (I) is a difunctional fluorene-based monomer having the structure

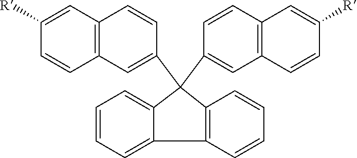

5. The composition of claim 1, comprising an epoxy binder system, wherein the compound having the general structure of formula (II) is a difunctional N-phenyl phenolphthalein-based monomer having the structure

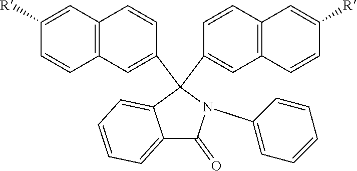

6. The composition of claim 1, wherein the difunctional monomer is a compound having the structure

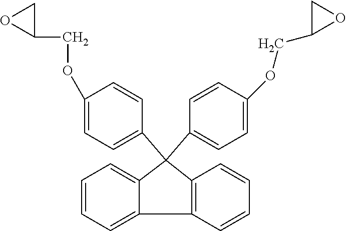 [SMILES: c1ccc2c(c1)-c1ccccc1C2(c1ccc(OCC2CO2)cc1)c1ccc(OCC2CO2)cc1]

7. The composition of claim 1, wherein the difunctional monomer is a compound having the structure

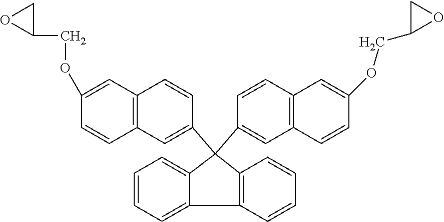 [SMILES: c1ccc2c(c1)-c1ccccc1C2(c1ccc2cc(OCC3CO3)ccc2c1)c1ccc2cc(OCC3CO3)ccc2c1]

8. The composition of claim 1, wherein the crosslinker is selected either anionically from an amine-based curing agent, such as a dihydrazide-based curing agent, a fluorene-based curing agent, or cationically from phenyl hydroxyl-based curing agent, organic acids, anhydrides, and appropriate mixtures or combinations thereof.

9. The composition of claim 1, wherein the catalyst is selected either anionic-ally from tertiary amines such as trialkyl amines, dialkylaryl amines, amine adducts, imidazoles, pyridines, imidazole adducts, urea derivatives, or cationic-ally from Lewis acids, salts of quaternary ammonium compounds, and mixtures or combinations thereof.

10. A crosslinking agent for an epoxy binder resin system, comprising a difunctional monomer having the structure 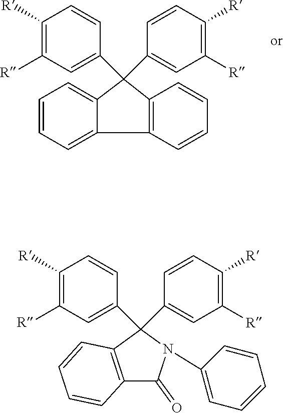
wherein
each R′ is independently —OH, NH₂, —COOH, and mixtures or combinations thereof; and
each R″ is independently —H or —CH₃, and
wherein the ratio of epoxy binder resin to crosslinker is about 1:1 to 5:1.

11. A coating composition, comprising:
a binder resin having cured Tg of greater than about 200° C., and including about 0.5 to 100 percent by weight of a difunctional monomer having the structure of a compound of general formula (I) or (II): 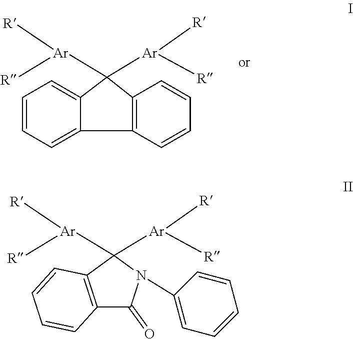
wherein
Ar is a C6 to C10 arylene group;
R′ is each independently a monomeric glycidyl or epoxide having the structure 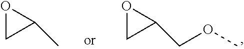
Or a monomeric acrylate, a polymer derived from one or more acrylate monomers, and mixtures or combinations thereof,
R″ is each independently —H, linear C1 to C4 alkyl, branched C1 to C4 alkyl, and mixtures or combinations thereof;
a crosslinker present in a ratio of 1:1 to 1:5 with respect to the binder resin; and
a catalyst present in an amount of about 0.1 to 4.0 phr.

12. The composition of claim 1, wherein the binder resin has cured Tg of up to about 250° C.

13. The composition of claim 1, wherein the composition is a liquid.

14. The composition of claim 1, wherein the composition is a powder.

15. The composition of claim 1, wherein a cured coating derived from the composition demonstrates optimal toughness or impact resistance.

16. The composition of claim 1, wherein a cured coating derived from the composition demonstrates optimal flexibility.

17. The composition of claim 1, wherein a cured coating derived from the composition demonstrates optimal cure and adhesion performance.

18. The composition of claim 1, wherein a cured coating derived from the composition demonstrates optimal water and moisture resistance.

19. The composition of claim 1, wherein a cured coating derived from the composition demonstrates optimal dielectric resistance.

20. The composition of claim 1, wherein the composition is applied to metal or non-metal substrates or as self-contained, and wherein the substrate is a structural steel member, pipelines (outer diameter, and inner diameter), substrates for highly corrosive environments, copper clad laminate substrates for use in 5G and 6G telecom networks, advanced electronics packaging adhesives materials, busbars, injection molding compounds, 3D printing, and pressured hydrogen barrier coatings.
